(19) United States
(12) Patent Application Publication
(10) Pub. No.: US 2016/0037801 A1
(43) Pub. Date: Feb. 11, 2016

(54) Plant-Based Food Product, Composition, and Methods

(71) Applicant: GOFIT FOODS, LLC, Laguna Hills, CA (US)

(72) Inventor: GEOFFREY MARGOLIS, LOS ANGELES, CA (US)

(21) Appl. No.: 14/920,620

(22) Filed: Oct. 22, 2015

Related U.S. Application Data
(63) Continuation of application No. 13/428,951, filed on Mar. 23, 2012, now abandoned.
(60) Provisional application No. 61/469,050, filed on Mar. 29, 2011.

(51) Int. Cl. A23J 3/18; A23J 3/00; A23J 3/22; A23J 3/16

(52) U.S. Cl. CPC A23J 3/18; A23J 3/16; A23J 3/04; A23J 3/227

(57) ABSTRACT

A flavor stabilized hydrated texturized plant protein may be produced by infusing dehydrated texturized plant protein particles with a water solution of one or more flavors and one or more heat denaturable soluble proteins. A binding and thickening water solution, including a heat denaturable soluble protein, a gum, an insoluble food protein, and/or a starch, may be added to the flavor stabilized hydrated texturized plant protein to create a formable mass. Fat may be added to the formable mass to produce a mass of generally moist crumbly pieces, wherein the crumbly pieces are generally surrounded by the binder/thickener. The formable mass and/or one or more portions thereof containing the generally moist crumbly pieces may then be formed into one or more plant-based food products such as, e.g., a patty, a loaf, a ball, lasagna, sausage, pizza topping(s), chili, and/or other food products that normally contain small pieces of meat.

### RELATED APPLICATION DATA

This application is a continuation of U.S. patent application Ser. No. 13/428,951, filed Mar. 23, 2012, which claims priority from Provisional Application Ser. No. 61/469,050, filed Mar. 29, 2011, all of which are incorporated herein by reference in their entirety.

### FIELD OF THE INVENTION

Embodiments of the present invention relate generally to plant-based food products and to methods and compositions used in producing same. More particularly, embodiments of the invention relate to methods for producing a flavor stabilized hydrated texturized vegetable/plant protein, to compositions of heat denaturable soluble proteins and insoluble food protein(s) and/or gum(s) for use as a binding/thickening agent, to methods of optimizing the amount of water used to produce a plant-based food product of desired texture, to methods of producing a plant-based food product by using a combination of one or more of the aforementioned methods and/or compositions, and to the plant-based food product thus produced.

### BACKGROUND

It has been well established that both composition (particularly with respect to fat, protein, carbohydrates, and salt) and quantity of food eaten daily can have a significant impact on the health of consumers. More people in the United States die from heart disease than from any other medical condition, and a primary contributor to heart disease is the consumption of foods containing high levels of saturated fat. Equally, obesity resulting from over-indulgence of food and lack of exercise is becoming endemic in the United States and other wealthy nations, and is leading to significant increases in diabetes and hypertension in the general population.

With the so-called “baby boomers” starting to turn 65 years old and their recognition that food can indeed have a significant impact on their health, there is now a strong desire, particularly by this cohort of the population, to modify their diet in a healthier direction.

However, since “eating enjoyment” plays such a powerful role in what a consumer decides to eat, there frequently is a huge difference between the consumer's desire to eat healthy and what is actually eaten. This is largely the result of the fact that most healthier foods unfortunately do not taste as good as their less-healthy alternatives.

The hamburger is the most ubiquitous food product on the American market. Billions of them are sold annually and the vast majority is made from ground meat containing at least 20% fat. Although there are many reasons for the popularity of the hamburger, it is generally agreed that taste, juiciness, and texture are the most important. A great grilled hamburger patty is considered to have the taste and juiciness of grilled beef and a sufficiently solid texture so that the patty remains intact in the sandwich, yet is easy for the consumer to bite through, and the patty piece then easily disintegrates in the mouth after only a few mastications.

The ground beef hamburger patty achieves this unique combination of organoleptic sensations through the inherent properties of meat and the application of meat science.

Prior to forming a raw hamburger patty, meat cuts, frequently containing at least 20% fat, are ground in a meat grinder into various pieces ranging from ⅛ inch to ⅜ inch in size. The ground beef is then formed into patties, either manually for home and single restaurant use, or by high-speed patty-forming machinery that produce hundreds of patties per minute for wide scale distribution.

Forming a meat patty requires that the ground meat be sufficiently sticky to maintain its structure during and after being formed. The fat in the ground meat is normally sufficient to provide this cohesiveness for manually-prepared patties, but forming low fat patties can be difficult. However, when patties are formed on high-speed machinery, it is often necessary to cool the ground beef to a temperature of less than 32° F. to enhance the cohesive structure of the meat being formed into patties, so that the patties can remain intact during the forming process.

When a meat hamburger patty is grilled, the fat melts and various soluble proteins are exuded from the cooking meat. These soluble proteins, which denature at temperatures above 140° F., bind the cooked ground meat particles together and trap the molten fat between the meat particles. Thus, the hamburger patty is able to provide the consumer with a unique eating experience--both good and bad: since it is made from meat, it provides substantial protein (good), but also a lot of fat (bad). Its cooked structure is sufficiently integral to remain intact in the hamburger bun, yet readily breaks apart in the mouth during mastication. Further, since the ground meat pieces are of variable size, they provide textural variety in the mouth when the hamburger piece is chewed, and the variable piece sizes also allow space for the molten fat to accumulate and supply juiciness to the eating experience.

On the other hand, plant-based food products (vegetarian or vegan) have the potential to provide consumers with the healthy alternatives that they are seeking Plant-based foods are generally lower in fat, high in fiber, and can provide as much protein as meat-based products. Further, since plants require substantially less feed and energy for their nourishment, as compared to animals, plant-based foods are certainly derived from environmentally friendly raw materials.

Most plant-based food products attempt to mimic similar meat-based products and claim to provide a similar eating experience. However, this is not the case, and, although most plant-based burgers provide consumers with healthier alternatives to a meat-based hamburger, they are deficient in flavor, texture, and eating enjoyment.

Plant-based burgers attempt to simulate the meat pieces of a regular hamburger by using either small vegetable pieces or pieces of “texturized vegetable proteins” (TVP) in their formulation. Those plant-based burgers made largely from vegetable/cereal pieces such as rice, onions, mushrooms, oats, etc. contain less fat than regular meat hamburgers, but unfortunately are lacking in protein. However, their largest deficiency is in eating quality--they are soft and “mushy” in texture and lacking in meat flavor.

However, the majority of plant-based burgers use TVP particles (frequently made from soy) to provide both protein and improved texture to the product. Although the texturized vegetable protein particles can overcome the “mushy” texture of purely vegetable-based burgers, they still suffer from significant eating quality defects relative to a meat hamburger. Thus, currently-available commercial products have been found to have either too hard or too soft a texture, and there is a lack of piece size variety during mastication in the mouth. In addition, many of these commercial products lack authentic meat-like flavors. Also, frequently, after a few mastications, an unpleasant soy taste emerges indicating leaching of added meat-like flavors from the texturized vegetable protein particles' surface or interior.

Many of the commercially available plant-based burger eating-quality deficiencies can be attributed to how they are made. Manufacturers have been only partially successful in using vegetable pieces and/or texturized vegetable proteins to simulate the texture of a meat hamburger. Since these plant-derived pieces are not normally sticky like ground meat, various formulations have been used to provide binding cohesiveness to the pieces so that a patty can be formed and maintain its integrity through the manufacturing and grilling steps.

Generally, plant-based patties are manufactured by first placing defined quantities of vegetable pieces or texturized vegetable protein pieces in a mixing vessel together with meat-like flavors, spices, and, to provide binding to the pieces, insoluble protein powders (such as gluten or isolated soy protein) and/or gums, starches, and sometimes egg white powders. Water (frequently representing at least 60% of the formulation) is then added to the mixture in the mixing vessel, and the entire mass is mixed for a defined period. The meat-like flavors dissolve in the water and the flavored water is absorbed into or absorbed onto, the surface of the vegetable pieces or texturized vegetable protein. Water is further absorbed into the binding compounds so as to form a sticky mass that should hold together the vegetable pieces or texturized vegetable proteins during patty forming.

This method of manufacturing, where all the ingredients are simultaneously mixed together, has the advantage of simplicity. However, it has drawbacks regarding the flavor and texture of the plant-based patty that is produced. In particular, many of the insoluble protein powders, gums, and even finely powdered flavors do not easily dissolve in water. On the other hand, dry TVP rapidly absorbs water. As a consequence, the amount of flavors absorbed into the TVP can be reduced and variable, and the binding power of the liquid mass surrounding the hydrated pieces can also be quite variable. Frequently, this then results in the cooked patty having either a gummy or a too-firm texture.

Clearly plant-based burgers are not as acceptable to the consumer as meat-based hamburgers, as evidenced by the sales of plant-based burgers that still remain only a very small fraction of total hamburger sales. There is therefore a need for a substantially improved plant-based burger that can provide major health benefits and improved eating quality and enjoyment for consumers.

### SUMMARY

Methods are provided herein for preparing plant-based burgers with excellent nutritional characteristics that closely resemble the taste and texture of a meat hamburger. In one aspect, methods are described for preparing a plant-based burger containing similar quantities of protein but substantially less fat than a regular meat hamburger. In another aspect, methods are described for hydrating dry TVP particles with a water-based mixture of flavors and a heat denaturable soluble food protein so as to infuse and stabilize the flavors within the TVP particles.

In yet another aspect, methods are described for binding the flavor stabilized TVP particles together so that patties can be formed at high speeds on patty-forming equipment. In a further aspect, methods are described for binding the flavor-stabilized TVP particles so that upon grilling the formed patty, the cooked patty closely resembles the flavor, color, texture, and eating characteristics of a grilled meat hamburger.

Low-fat plant-based patty products are disclosed that closely resemble the flavor, color, texture, and eating characteristics of a grilled meat hamburger through the use of variable sized flavor-stabilized TVP particles, and concentrated solutions of heat denaturable soluble proteins, insoluble proteins, and heat thickening gums.

Thus, in one embodiment, a method for producing a flavor-stabilized hydrated texturized plant protein includes infusing dehydrated texturized plant protein particles with a water solution including both flavors and heat-denaturable soluble proteins.

In another embodiment, a method for producing a plant-based patty product includes hydrating dry texturized plant protein particles of variable sizes with a defined quantity of water solution of flavors and heat-denaturable soluble proteins, binding the dehydrated texturized plant protein particles together with a binding and thickening water solution to create a formable mass which may then be cooled, and forming the formable mass into patty shapes.

In yet another embodiment, a method for controlling and minimizing the amount of water needed to make a plant-based patty of desired texture includes separately hydrating texturized plant protein particles with a defined and limited quantity of water, preparing a concentrated binding and thickening solution by dissolving and hydrating binding and thickening agents in a minimum amount of water necessary to make the binding and thickening solution usable for binding the hydrated texturized plant protein particles into a formable mass, and forming the formable mass into patty shapes.

In another embodiment, a composition for a binding system to be used in binding hydrated texturized plant proteins into a formable mass includes heat-denaturable soluble proteins, one or more of insoluble food proteins and gums, and the minimal amount of water necessary to solubilize the heat-denaturable soluble proteins.

### BRIEF DESCRIPTION OF THE DRAWING

FIG. 1 is a flow diagrams showing steps, components, and compositions in accordance with embodiments of the invention.

### DETAILED DESCRIPTION

Methods are described for preparing a plant-based burger that, upon consumption, closely resembles the taste, texture, and color of a regular grilled meat hamburger, yet is healthier for the consumer to eat.

The plant-based burgers described herein are made from texturized plant proteins, which are a good source of protein. In addition, the texturized plant proteins, which are supplied as dehydrated particles, are available in different sizes and shapes. Thus, according to one embodiment of the present invention, TVP particles of various sizes, shapes, and speed of water-absorption are used to make the plant-based burger. These different types of TVP provide the textural variety to the patty, thus simulating the various meat piece sizes in a meat hamburger.

In order to resemble the taste of a regular grilled meat hamburger, it is essential to both mask the inherent soy flavor of the TVP particles used in preparing the plant-based burger, and to also provide an authentic meat-like flavor to the TVP pieces. Further, it is important that this meat-like flavor not readily leach out of the TVP during mastication thus returning the inherent soy flavor of the TVP.

According to one embodiment of the present invention, dry TVP pieces of various sizes, shapes, and speed of water-uptake are hydrated by a water solution containing meat-like flavor and heat denaturable soluble food proteins. The TVP pieces and the water solution are mixed until the entire water solution has been absorbed by the TVP. Typically, a ratio of around 2.6/1 water to TVP is used, but other ratios will also work. The meat-like flavors are generally reaction-type flavors produced by Maillard reactions; and heat denaturable soluble food proteins such as egg white (albumen), whey proteins, fractionated soy proteins, etc. can be used, provided that the proteins denature and solidify in a temperature range from about 120° F. to about 180° F.

Hydrating the TVP in this manner guarantees that the flavor to TVP ratio is well defined. In addition, as the patty is being grilled (cooked) and its internal temperature rises above 150° F. (which is required for food safety reasons), the heat denaturable proteins within the TVP solidify, sealing the flavor components within the hydrated TVP particles. In this manner, when the plant-based patty is eaten, the meat-like flavors are uniform during the entire time that the patty is being chewed in the consumer's mouth, since the flavors cannot easily be leached out of the TVP by saliva. As such, the inherent and unacceptable soy flavor of the TVP is essentially masked.

Clearly, these flavor-stabilized TVP particles can also be used for other plant-based food product alternatives to meat products. For example, they can be used in chilis, soups, pizza toppings, sauces, or any food product that normally would contain small pieces of meat.

Another embodiment of this invention is directed to methods for replicating the structure and texture of a meat hamburger in a plant-based burger. Surprisingly, it has been discovered that this can be achieved by a combination of processing and formulation changes.

Although the flavor-stabilized hydrated TVPs provide piece textural variety, these pieces have to be bound together so that a patty can be formed and maintain its structure throughout grilling. However, for eating enjoyment, the grilled patty needs to also be sufficiently friable that upon entering the consumer's mouth the burger chunk can disintegrate within a few mastications.

It has been discovered that with water management and the use of heat denaturable soluble foods proteins and binding agents it is possible to achieve this desired texture.

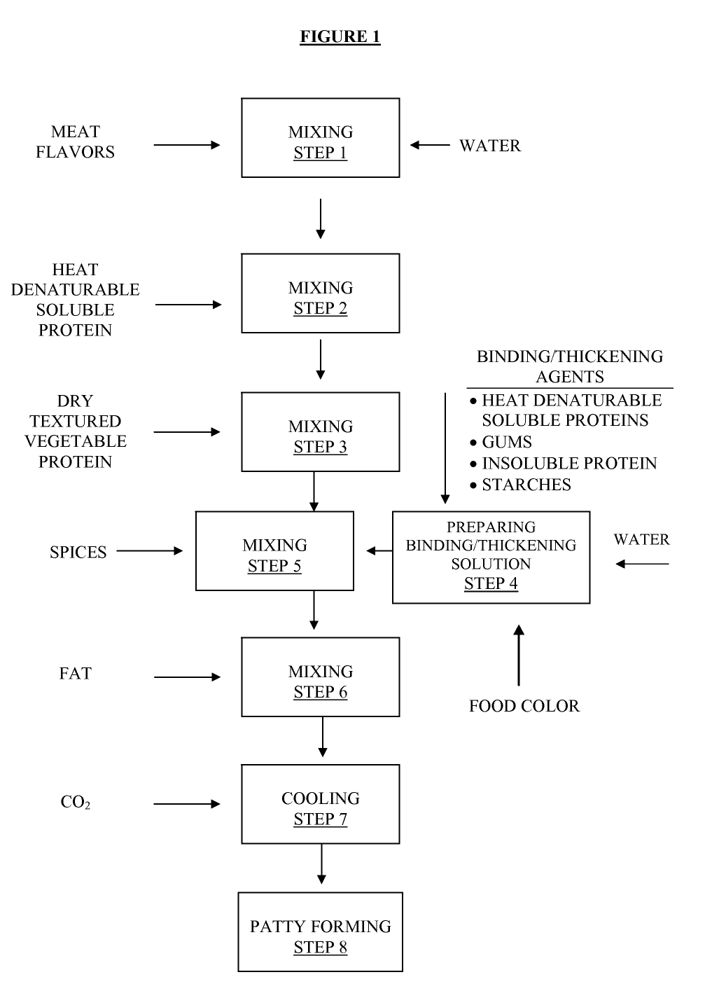

One embodiment of the invention is shown in FIG. 1. As indicated, the methodology requires a sequence of well-defined steps designed to stabilize the meat flavors in the TVP, and to create the desired product texture by careful water management and the use of heat dependent binding and thickening agents.

In Step 1 of FIG. 1, defined quantities of meat flavors are dissolved in a defined quantity of water. A defined quantity of heat denaturable soluble proteins such as “liquid egg white” is then mixed into the meat flavor solution (Step 2). Alternatively, the defined quantities of meat flavors and heat denaturable soluble proteins can be simultaneously dissolved in a defined quantity of water. The combined liquid mixture is added to a pre-weighed quantity of dry texturized vegetable protein placed in a mixing vessel. The TVP and added liquid mixture are mixed for about 40 minutes, by which time all the flavored/protein liquid mixture has been absorbed by the TVP (Step 3). The hydrated TVP is allowed to stand for an additional 30 to 40 minutes to allow complete diffusion of the absorbed liquid into the pores of the TVP.

During the hydrated TVP waiting period, the binding/thickening solution is prepared by completely dissolving and hydrating the binding/thickening agents together with any food grade colorants into a defined quantity of water (Step 4). Once the hydrated TVP waiting period is over, the binding/thickening solution is added to the hydrated TVP and the mixture is mixed for about 4 minutes (Step 5) to produce a thick moist but semi-solid mass. Fat (preferably solid pieces at room temperature) is then added (Step 6) and mixed in for about 2 minutes.

Surprisingly and unexpectedly, the addition of the fat at this point in the processing sequence causes the TVP/binder/thickener moist mass to become drier and to produce a mass of generally moist crumbly pieces which are generally surrounded by the binder/thickener. The mass of these moist crumbly pieces is then cooled with dry ice (solid carbon dioxide) to a temperature of between about 27° F. and about 29° F. (depending on formulation) (Step 7). The cooling stiffens the mass of the moist crumbly pieces so that they can be easily formed in a high-speed forming machine.

As a variant to the above-described embodiment, portions of the mass of moist crumbly pieces produced in Step 6 of FIG. 1 can also be used to form plant-based “meat balls,” “meat loaf,” lasagna, sausages, or any other food product that would normally be made with ground meat.

In a further embodiment of the invention, it has been discovered that the hydrated binding/thickening agents used in Steps 4 and 5 (FIG. 1) also provide juiciness to the plant-based burger when consumed. As a consequence, it is only necessary to add between ⅓ and ½ the amount of fat (Step 6) as compared to a 20% fat meat hamburger, when manufacturing the plant-based burger. This is a significant nutritional advantage.

The following specific examples are provided for purposes of illustrating various aspects of the invention, and no limitations are intended thereby.

### Example 1 and 2

Examples 1 and 2 were undertaken to demonstrate the effectiveness of using heat denaturable food proteins to minimize flavor leaching from hydrated TVP.

Texturized vegetable proteins were hydrated either with water or with a mixture of water and liquid egg white (albumin). In both cases, a blue food grade dye was added to the hydrating solution.

Table 1 presents the formulations used to prepare the product made with liquid egg white (Example 1) and without liquid egg white (Example 2). 300 grams of hydrated TVP were prepared for both examples.

The TVP, egg white solution (Example 1) and additional hydration water percentages were chosen to approximate the relative percentages that were used in preparing various complete plant-based burgers (see, e.g., Examples 6 and 8).

In the case of Example 1, a liquid egg white solution was first prepared by slowly dissolving powdered egg white into water using a whisk. The dried egg powder to water ratio of 1/9 was chosen to make a liquid egg solution similar to liquid egg whites obtained directly from eggs. Salt (to simulate flavors), blue food coloring, and additional hydration water were added to the liquid egg white solution according to the formulation presented in Table 1.

TABLE 1

| | Example 1 | Example 2 |
|---|---|---|
| | (With Egg) | (Without Egg) |
| | % by weight | % by weight |
| TVP | | |
| Thin flaked structure¹ | 10.5 | 10.8 |
| Rapid water absorber² | 11.86 | 12.2 |
| Slow water absorber³ | 4.25 | 4.38 |
| Liquid Egg for Hydration | | |
| Dried Egg Powder | 2.8 | — |
| Water for Solubilizing Egg | 25.2 | 25.9 |
| Hydration Water | 44.39 | 45.695 |
| Salt | 0.9 | 0.925 |
| Blue Food Colorant | 0.1 | 0.1 |
| | 100.00 | 100.00 |
| Water/TVP | 2.61 | 2.61 |

¹E.g., Response ® 4412* (thin powdery flakes, about 1/32″ thick by about ≦⅛″ long).
²E.g., Response ® 4320* (irregular pieces, about ⅛″ to about 3/16″ in diameter, rapid water absorber).
³E.g., Response ® 4381* (irregular pieces, about ⅛″ to about 3/16″ in diameter, slow water absorber).
*Response ® products manufactured by Solae LLC, St. Louis, MO.

A mixture of various TVP products was then weighed and placed in a small plastic container, to which the liquid hydrating solution (containing liquid egg white, salt and blue dye) was added and the solid/liquid was manually mixed every 2-3 minutes until all the liquid had been absorbed by the TVP (approximately 40 minutes).

Hydrated TVP for Example 2 was prepared in a similar fashion, except that no egg white powder was used. However, a similar total water-to-TVP ratio was maintained.

The two hydrated TVP products were allowed to stand for two hours for complete equilibration. Then, 50 grams of each hydrated TVP was placed in two different frying pans, each heated to about 360 ° F., and the TVP crumbles were continuously mixed for 5½ minutes. This heating time was similar to the time used in grilling the plant-based burgers and served to heat the crumbles to a temperature in excess of 165° F.

At the end of the “grilling” period, approximately 30 grams of each hydrated TVP was placed in about 250 ml of water in two separate glass containers, and each was stirred with a spoon for approximately 2-3 minutes. The water in the glass containing TVP from Example 2 turned a strong blue color. The water in the glass containing TVP from Example 1 remained essentially clear with a very slight blue color.

This confirmed that the addition of heat denaturable food proteins in the meat-flavored liquid used to hydrate TVP will seal the absorbed flavors within the TVP particles.

### Examples 3, 4, and 5

In manufacturing plant-based burgers, it is necessary to sufficiently bind together the hydrated TVP pieces so that patties can be made on high-speed machinery. However, it is also essential that the eating quality of the grilled burger still be maintained for widespread consumer acceptance of the burgers, i.e., the burger patty should have a texture similar to what is found in meat hamburgers.

Examples 3, 4, and 5 demonstrate the effectiveness of various binding and thickening agents in binding the hydrated TVP pieces together through patty forming and grilling, while still maintaining eating quality.

Table 2 presents the formulations used to prepare Examples 3, 4, and 5. In all cases, larger quantities of products ranging from 4 kgs to 20 kgs were prepared so that patties could be made on industrial continuously-operating patty forming equipment.

In Example 3, the binding system consisted only of a mixture of liquid egg white solution and dried egg white powder.

Egg white(s) (albumen) are a mixture of heat denaturable soluble proteins which denature (solidify) in a temperature range between 140° F. and 180° F. As such, egg whites are frequently used in various baked foods, meatloafs, souffles, etc., to provide structure to the cooked product. Unfortunately, egg white solutions are low in viscosity and as such are somewhat lacking in binding power when they are not heat denatured.

In Example 4, an insoluble isolated soy protein powder (Supro 38, manufactured by Solae LLC, St. Louis, Miss.) was added to the liquid egg/dried egg mixture to thicken it and provide some viscosity by absorbing water from the liquid egg white solution.

In Example 5, a gum (in this case, Methocel™ A16m, which is a methylcellulose gum manufactured by The Dow Chemical Co., Midland, Mich.) was added to the liquid egg/dry egg mixture to thicken and provide viscosity to the egg solution, by absorbing water from the liquid egg white solution.

There are many vegetable gums (e.g., carrageenan, xanthan, guar, etc.) that are used for thickening. All of these gums form thicker, more viscous solutions at colder temperatures and thinner, less viscous solutions at elevated temperatures. Methocel, on the other hand, is a gum whose solution thickens as the temperature is elevated above 120° F.

Products for Examples 3, 4, and 5 were prepared according to the sequences of FIG. 1, and described in the Detailed Description section.

TABLE 2

| | | Example 4 | Example 5 |
|---|---|---|---|
| | | (Egg & | (Egg & Heat |
| | Example 3 | Isolated Soy | Firming |
| | (Only Egg) | Protein¹) | Gum²) |
| | % by weight | % by weight | % by weight |
| TVP | | | |
| Thin flaked structure³ | 7.5 | 7.4 | 7.4 |
| Rapid water absorber⁴ | 7.5 | 8.4 | 7.4 |
| Slow water absorber⁵ | 3.0 | 3.0 | 3.0 |
| Liquid Egg for Hydration | | | |
| Dried Egg Powder | 1.2 | 1.0 | 1.2 |
| Water for Solubilizing Egg | 9.8 | 9.0 | 9.8 |
| Flavors | 2.27 | 2.59 | 2.27 |
| Hydration Water | 36.31 | 38.40 | 36.01 |
| Binding/Thickening Solution | | | |
| Dried Egg Powder | 1.0 | 1.0 | 1.0 |
| Dried Egg for Egg Solution | 2.0 | 2.0 | 2.0 |
| Water for Solubilizing Egg | 18.0 | 18.0 | 18.0 |
| Isolated Soy Protein¹ | — | 1.0 | — |
| Heat Firming Gum² | — | — | 0.5 |
| Spices | 0.77 | 0.67 | 0.77 |
| Dextrose | 0.45 | 0.44 | 0.45 |
| Caramel Color | 0.2 | 0.1 | 0.2 |
| Fat⁶ | 10.0 | 7.0 | 10.0 |
| | 100.00 | 100.00 | 100.00 |

¹E.g., Supro ® (Supro EX 38 manufactured by Solae LLC, St. Louis, MO).
²E.g., Methocel ™ (Methocel A16m manufactured by The Dow Chemical Co., Midland, MI).
³E.g., Response ® 4412* (thin powdery flakes, about 1/32″ thick by about ≦⅛″ long).
⁴E.g., Response ® 4320* (irregular pieces, about ⅛″ to about 3/16″ in diameter, rapid water absorber).
⁵E.g., Response ® 4381* (irregular pieces, about ⅛″ to about 3/16″ in diameter, slow water absorber).
⁶E.g., SansTrans ™ 39 (supplied by Loders Croklaan, Channahon, IL).
*Response ® products manufactured by Solae LLC, St. Louis, MO.

All products made according to the formulations of Examples 3, 4, and 5 were able to be formed into patties on continuously-operating equipment. On grilling the formed patties, those made according to Examples 3 and 4 easily broke apart, whereas the patties made according to Example 5 maintained their structure reasonably during grilling. However, the binding/thickening formulation used in Example 5 was still not thick enough to prevent the liquid egg white from flowing out of the patty during grilling.

The eating quality (taste, texture in mouth, and lack of soy taste) for products made according to Examples 3, 4, and 5 was good and substantially better than other commercially available plant-based burgers.

### Examples 6, 7, and 8

Examples 3, 4, and 5 demonstrated that it was possible to manufacture plant-based burgers of substantially improved eating quality.

However, patty integrity during grilling was still not optimum. This presents a major problem for widespread distribution of these burgers in chain restaurants. In chain restaurants, product uniformity and speed of preparation is very important and, as such, the maintenance of patty integrity during grilling is critical. Further, depending on the type of sandwich a restaurant desires to sell, different patties are required, most frequently ranging in weight from a ¼ lb patty to a ⅛ to 1/10 lb patty.

Patty size presents an additional problem to patty integrity during grilling, and actually it is more difficult to prevent the smaller patties from breaking during grilling than the larger ones. This applies both to meat hamburgers and plant-based burgers, and is due to reduced binding capabilities in the smaller patties.

It has been discovered that two major formulation changes are required in order to produce plant-based burgers that could be manufactured at high speed, be grilled without partly disintegrating, and which would supply superior eating quality.

First, a more concentrated egg white solution was made by reconstituting egg white powder in a lower quantity of water. It was discovered that a more concentrated egg solution could be made using as little as one part egg white powder to five parts water (as compared to normal liquid egg white which is one part white solids to nine parts water). Thus, the lower quantity of water needed for reconstitution of the egg white powder resulted in substantial improvements in thickening and binding.

Then, a combination of a gum (e.g., Methocel™) and isolated soy protein was added to the concentrated egg white solution to produce an even thicker viscous binding solution so as to more easily hold the hydrated TVP pieces together during patty forming.

Since the more concentrated binding solution now contained two components (egg white protein and methocel), both of which solidified at grilling temperatures, the patties were able to maintain their structure through the grilling process yet be sufficiently friable to easily disintegrate during mastication.

Table 3 presents the formulations used in making products representing Examples 6, 7, and 8. In all cases, larger quantities of products ranging from 4 kg to 40 kgs were prepared so that patties could be made on industrial continuously-operating patty-forming equipment. Examples 6 and 8 were made according to the sequences in FIG. 1 and described in the Detailed Description section.

TABLE 3

| | | Example 8 |
|---|---|---|
| | Examples 6 & 7 | % by |
| | % by weight | weight |
| TVP | | |
| Thin flaked structure¹ | 7.90 | 7.90 |
| Rapid water absorber² | 8.90 | 8.90 |
| Slow water absorber³ | 3.20 | 3.20 |
| Liquid Egg for Hydration | | |
| Dried Egg Powder | 2.10 | 2.10 |
| Water for Solubilizing Egg | 18.90 | 18.90 |
| Flavors | 2.80 | 2.75 |
| Hydration Water | 33.47 | 33.22 |
| Binding/Thickening Solution | | |
| Dried Egg Powder | 2.0 | 2.0 |
| Water for Solubilizing Egg | 12.0 | 12.0 |
| Isolated Soy Protein⁴ | 0.3 | 0.5 |
| Heat Firming Gum⁵ | 0.35 | 0.45 |
| Spices | 0.48 | 0.48 |
| Dextrose | 0.5 | 0.50 |
| Caramel Color | 0.1 | 0.10 |
| Fat⁶ | 7.0 | 7.0 |
| | 100.00 | 100.00 |

¹E.g., Response ® 4412* (thin powdery flakes, about 1/32″ thick by about ≦⅛″ long).
²E.g., Response ® 4320* (irregular pieces, about ⅛″ to about 3/16″ in diameter, rapid water absorber).
³E.g., Response ® 4381* (irregular pieces, about ⅛″ to about 3/16″ in diameter, slow water absorber).
⁴E.g., Supro ® (Supro EX 38 manufactured by Solae LLC, St. Louis, MO).
⁵E.g., Methocel ™ (Methocel A16m manufactured by The Dow Chemical Co., Midland, MI).
⁶E.g., SansTrans ™ 39 (supplied by Loders Croklaan, Channahon, IL).
*Response ® products manufactured by Solae LLC, St. Louis, MO.

Example 6 was formed into ¼ lb patties (⅜″ in thickness), and Example 8 was formed into ⅛ lb patties (¼″ in thickness).

Example 7, however, used the exact same formulation as Example 6, but was prepared according to the traditional manufacturing procedures. Thus, all the dry ingredients (except fat) together with water were placed in a mixer and mixed for about 40 minutes until all the liquid had been absorbed. The fat was then added and mixed with the other ingredients for an additional two to three minutes, after which the entire mass was cooled with dry ice (solid CO₂) to a temperature of 28° F.

The patties from Example 7 were also formed into ¼ lb patties (⅜″ in thickness).

Products from all three Examples (6, 7, and 8) could be formed on continuously-operating patty-forming equipment.

The patties made according to Example 6 required about 8 minutes to be grilled and maintained their integrity during grilling. The patties made according to Example 7 equally required about 8 minutes to be grilled, but were much more delicate during grilling and frequently broke apart during grilling.

Finally, the patties made according to Example 8 only required 5 minutes to be grilled (due to the fact that the patties were ¼″ thick) and maintained their integrity during grilling.

Clearly, proper water control—both according to the procedure described in FIG. 1 and through the use of more concentrated binding solutions--are essential for the successful manufacture and preparation of burgers.

Burgers made according to Examples 6 and 8 were considered by consumers to be as acceptable as meat hamburgers. Further, these burgers were healthier to consume than regular meat hamburgers since they provided substantially similar quantities of protein, but with about ⅓ to ½ the amount of fat.

Due to factors such as the concentration, heat affected binders/thickeners used in these examples, etc., the egg white solution did not flow out of the patties during grilling. This accentuated the charred colorations of the variable patty surface, making the grilled burger look very similar to a grilled meat hamburger.

A mixture of flavor stabilized TVP particles containing at least 50%, and preferably 60%, irregular sized pieces of around ⅛ inch to 3/16 inch in diameter, some of which absorbed water more slowly than others, together with fine flaked TVP which filled the interstices between the irregular larger-sized TVP particles, was needed to simulate both the textural variety and the surface look of a meat hamburger. The interstices were additionally filled with binder(s).

A concentrated water-based binding/thickening solution containing heat denaturable proteins, gums, and other thickeners provided both textural strength for manufacturing and grilling and friability during mastication. This binding solution also gave the plant-based burger added juiciness so that only 7% to 10% fat was needed in the formulation, thereby producing a healthier alternative to the meat hamburger.

By modifying the composition of the binders and thickeners (see, e.g., formulation of Examples 6 and 8), it was possible to increase the structural strength of the smaller ¼ inch patty (Example 8) so that it maintained its integrity during grilling, and yet remained acceptable for eating enjoyment.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, and all changes which come within the meaning and range of equivalency of the claims are therefore intended to be embraced therein.

What is claimed is:

1. A method of producing a plant-based food product, the method comprising:
(a) dissolving one or more flavors and one or more heat denaturable soluble proteins in a first quantity of water to produce a water solution of one or more flavors and one or more heat denaturable soluble proteins, wherein said first quantity of water constitutes all of the water in said water solution;
(b) hydrating dry texturized plant protein particles with said water solution to obtain hydrated texturized plant protein particles, wherein said first quantity of water is substantially all absorbed by said dry texturized plant protein particles;
(c) after said hydrating step, adding a binding and thickening water solution to the hydrated texturized plant protein particles so as to create a formable mass;
(d) adding solid fat pieces at room temperature to the formable mass; and
(e) forming the formable mass or one or more portions thereof into said food product.

2. The method of claim 1, wherein the dry texturized plant protein particles include particles of different water-absorption speeds.

3. The method of claim 1, wherein said first quantity of water in step (a) is optimized based on the quantity of the one or more heat denaturable soluble proteins.

4. The method of claim 3, wherein said first quantity of water in step (a) is such that the ratio of the water solution to the texturized plant protein particles is about 2.6 on a weight percentage basis.

5. The method of claim 1, wherein the heat denaturable soluble protein is albumen.

6. The method of claim 1, wherein the binding and thickening water solution includes at least one member selected from the group consisting of a heat denaturable soluble protein, a gum, an insoluble food protein, and a starch.

7. The method of claim 6, wherein the insoluble food protein includes at least one of gluten powder and isolated soy protein powder.

8. The method of claim 6, wherein the heat denaturable soluble protein for the binding and thickening water solution includes at least one of a liquid egg white solution and a dried egg white powder.

9. The method of claim 6, wherein the heat denaturable soluble protein for the binding and thickening water solution is a concentrated egg white solution made by reconstituting one part egg white powder in at least 5 parts of water.

10. The method of claim 9, wherein the concentrated egg white solution is made by reconstituting one part egg white powder in at most 9 parts of water.

11. The method of claim 6, wherein the binding and thickening water solution further includes food color.

12. The method of claim 1, wherein the heat denaturable soluble protein is fractionated soy protein.

13. The method of claim 1, wherein one or more spices are added to the formable mass prior to step (e).

14. The method of claim 1, wherein at least one of dextrose and caramel color is added to the formable mass prior to step (e).

15. The method of claim 1, wherein the fat that is added in step (d) makes up between about 7% and about 10% by weight of the formable mass and fat combination.

16. The method of claim 1, wherein said food product is a patty-shaped food product.

17. The method of claim 1, wherein, prior to step (c), the hydrated texturized plant protein particles are allowed to stand for a period of about 30 to about 40 minutes so as to allow substantially full absorption of the water solution by the texturized plant protein particles.

18. The method of claim 1, wherein said food product is produced using continuously-operating equipment.

19. The method of claim 1, further including heating said food product so as to denature said heat denaturable soluble proteins.

20. A method of producing a plant-based food product, the method comprising:
(a) dissolving one or more flavors and one or more heat denaturable soluble proteins in a first quantity of water to produce a water solution of one or more flavors and one or more heat denaturable soluble proteins, wherein said first quantity of water constitutes all of the water in said water solution;
(b) hydrating dry texturized plant protein particles with said water solution to obtain hydrated texturized plant protein particles, wherein said first quantity of water is substantially all absorbed by said dry texturized plant protein particles;
(c) after said hydrating step, adding a binding and thickening water solution to the hydrated texturized plant protein particles so as to create a formable mass;
(d) adding solid fat pieces at room temperature to the formable mass, wherein said solid pieces of fat are mixed with the formable mass to produce a mass of generally moist crumbly pieces, and wherein said crumbly pieces are surrounded by said binding and thickening water solution;
(e) cooling the mass of generally moist crumbly pieces to a temperature of between about 27° F. and 29° F.; and
(f) forming the cooled mass of generally moist crumbly pieces or one or more portions thereof into said food product.

21. The method of claim 20, wherein the plant-based food product is used in one or more members selected from the group consisting of lasagna, sausage, a loaf, a ball, one or more pizza toppings, chili, and other food products normally containing small pieces of meat.

22. The method of claim 20, wherein, in step (f), the mass of generally moist crumbly pieces is formed into a patty.

23. The method of claim 20, wherein the binding and thickening water solution includes at least one member selected from the group consisting of a heat denaturable soluble protein, a gum, an insoluble food protein, and a starch.

24. The method of claim 23, wherein the insoluble food protein includes at least one of gluten powder and isolated soy protein powder.

25. The method of claim 23, wherein the heat denaturable soluble protein for the binding and thickening water solution includes at least one of a liquid egg white solution and a dried egg white powder.

26. The method of claim 20, wherein the one or more flavors include meat-like flavors.
